(19) United States
(12) Patent Application Publication
(10) Pub. No.: US 2014/0133686 A1
(43) Pub. Date: May 15, 2014

(54) APPARATUS TO PREVENT EXCESS MOVEMENT OF MEMS COMPONENTS

(71) Applicant: Knowles Electronics, LLC, Itasca, IL (US)

(72) Inventor: Sung Bok Lee, Chicago, IL (US)

(73) Assignee: Knowles Electronics, LLC, Itasca, IL (US)

(21) Appl. No.: 14/075,799

(22) Filed: Nov. 8, 2013

Related U.S. Application Data
(60) Provisional application No. 61/726,291, filed on Nov. 14, 2012.

(51) Int. Cl. H04R 1/04

(52) U.S. Cl. CPC H04R 1/04
USPC 381/355

(57) ABSTRACT

An acoustic device includes a substrate, a microelectromechanical system (MEMS) apparatus, a cover, a port, and a stop. The MEMS apparatus includes a diaphragm and a back plate. The cover is coupled to the substrate and encloses the MEMS apparatus. The port is disposed through the substrate, and the MEMS apparatus is disposed over the port. The stop is disposed over the MEMS apparatus and configured to prevent movement of portions of the MEMS apparatus that would damage the portions of the MEMS apparatus.

### CROSS REFERENCE TO RELATED APPLICATION

This patent claims benefit under 35 U.S.C. §119 (e) to U.S. Provisional application No. 61/726291, filed Nov. 14, 2012 and entitled “Apparatus to Prevent Excess Movement of MEMS Components,” the content of which are incorporated herein by reference in their entirety.

### TECHNICAL FIELD

This application relates to acoustic devices, and more specifically to preventing damage to these devices.

### BACKGROUND OF THE INVENTION

MicroElectroMechanical System (MEMS) devices include microphones and speakers to mention two examples. In the case of a MEMS microphone, sound energy enters through a sound port and vibrates a diaphragm and this action creates a corresponding change in electrical potential (voltage) between the diaphragm and a back plate disposed near the diaphragm. This voltage represents the sound energy that has been received. Typically, the voltage is then transmitted to an electric circuit (e.g., an integrated circuit such as an application specific integrated circuit (ASIC)). Further processing of the signal may be performed on the electrical circuit. For instance, amplification or filtering functions may be performed on the voltage signal at the integrated circuit.

The components of the microphone are typically disposed on a printed circuit board (PCB), substrate, or base, which also may provide electrical connections between the microphone components as well as providing a physical support for these components.

Microphones are sometimes subject to high pressure events. For example, the device in which the microphone is disposed may be dropped or struck. This may create a high energy pressure that enters the microphone via ports in the microphone and damages the internal microphone components. For various reasons, current approaches have not proved adequate in protecting these devices from such events.

### BRIEF DESCRIPTION OF THE DRAWINGS

For a more complete understanding of the disclosure, reference should be made to the following detailed description and accompanying drawings wherein:

FIG. 1 comprises a cutaway side view of a microphone device with a stop according to various embodiments of the present invention;

FIG. 2 comprises a cutaway side view of a microphone device with a stop according to various embodiments of the present invention;

FIG. 3 comprises a perspective view of a microphone device with a stop according to various embodiments of the present invention;

FIG. 4 comprises a perspective view showing portions of the microphone device of FIG. 3 according to various embodiments of the present invention;

FIG. 5 comprises a perspective view of the stop of the microphone device of FIGS. 3 and 4 looking at the stop from the bottom upward according to various embodiments of the present invention;

FIG. 6 comprises a perspective view of a microphone device of FIGS. 3-5 with a stop according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are provided that provide protection for the internal components of microphones from high pressure transients of sound energy. More specifically, a stop or other convenient element is used to prevent the back plate or the diaphragm of the microphone from moving beyond a distance that would damage the back plate, diaphragm, or other components during a high pressure event. Since the back plate or the diaphragm does not move beyond a distance that would cause it or other components damage, damage to the microphone and its internal components is prevented from occurring during high pressure events. The approaches described here mainly refer to limiting the movement of the back plate, but they are equally applicable to limiting the movement of the diaphragm.

In many of these embodiments, an acoustic device includes a substrate, a microelectromechanical system (MEMS) apparatus, a cover, a port, and a stop. The MEMS apparatus includes a diaphragm and a back plate. The cover is coupled to the substrate and encloses the MEMS apparatus. The port is disposed through the substrate, and the MEMS apparatus is disposed over the port. The stop is disposed over the MEMS apparatus and configured to prevent movement of portions of the MEMS apparatus that would damage the portions of the MEMS apparatus.

In some aspects, the stop extends over and around the MEMS apparatus and is coupled to the substrate. In other aspects, the stop is coupled to the cover. In still other aspects, the stop is support by at least one pedestal. In yet other aspects, the at least one pedestal is coupled to the substrate or the MEMS or both.

In other examples, the portions of the MEMS apparatus for which damage is prevented from occurring is the back plate. In other examples, the portions of the MEMS apparatus for which damage is prevented from occurring is the diaphragm. In yet other examples the portion of the MEMS apparatus for which damage is prevented from occurring is any movable component for which damage can occur from excessive movement.

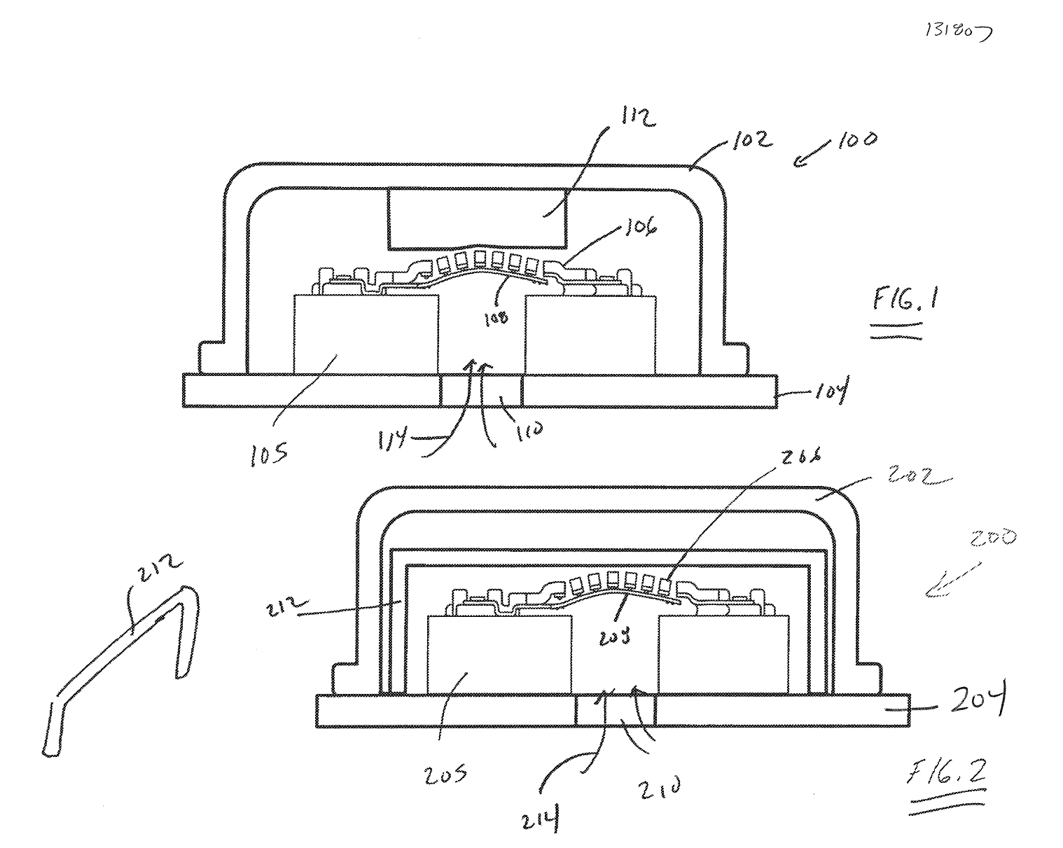

Referring now to FIG. 1, a MEMS microphone apparatus 100 is shown. The microphone apparatus 100 includes a cover 102, base 104, back plate 106, diaphragm 108. The back plate 106 and diaphragm 108 rest on MEMS die 105. A port 110 extends through the base 104. A stop 112 is disposed on the underside of the cover 102. The stop 112 prevents the back plate 106 from moving beyond a predetermined distance since when the back plate moves beyond this predetermined distance, damage to the back plate 106 or other components of the microphone apparatus 100 may occur. In one example, the stop 112 is constructed of metal or (??) plastic and has dimensions of approximately 1 mm by 1 mm and 0.25 mm thick. In this example, the microphone apparatus 100 is approximately 1 mm tall and under no pressure the separation between the stop 112 and the back plate 106 is approximately 20 micro meters. The stop 112 can be any conveniently shaped structure with any appropriate dimensions. Thus, the distance between the back plate and the stop (under no pressure) can be adjusted to fit the needs of the user and the system.

In one example of the operation of the microphone 100, sound energy 114 enters through the port 110 and vibrates the diaphragm 108 and this action creates a corresponding change in electrical potential (voltage) between the diaphragm 108 and the back plate 106. This voltage represents the sound energy that has been received. The voltage may be then transmitted to an electric circuit (e.g., an integrated circuit such as an application specific integrated circuit (ASIC) and not shown in the figure). Further processing of the signal may be performed on the electrical circuit. For instance, amplification or filtering functions may be performed on the voltage signal at the integrated circuit. The stop 112 prevents the back plate 106 from moving any further distance beyond a predetermined distance when the sound pressure 114 exceeds a predetermined pressure. This prevents damage to the back plate 106 or other components of the microphone 100. In other words, the back plate does not break or break off and no damage to other components occurs during high pressure sound events (e.g., high pressure sound entering via the port 110). When the level of sound pressure does not exceed a predetermined amount, the back plate 106 is not bent to a distance where it touches the stop 112.

Referring now to FIG. 2, another example of a MEMS microphone apparatus is shown. The microphone apparatus 200 includes a cover 202, base 204, back plate 206, diaphragm 208. The back plate 206 and diaphragm 208 rest on MEMS die 205. A port 210 extends through the base 204. A stop 212 is disposed on the base 204 and extends across the back plate 206. The stop 212 prevents the back plate 206 from moving beyond a predetermined distance since when the back plate moves beyond this predetermined distance, damage to the back plate 206 or other components of the microphone 200 may occur. In one example, the stop 212 is a thin bar constructed of plastic. In other examples, the stop 212 is wider and covers a great area of the back plate 206. In one example, the stop 212 is constructed of plastic or metal and has dimensions of approximately 0.5 mm wide, approximately 1 mm long, and approximately 270 micrometers tall. In this example, the microphone apparatus 200 is approximately 1 mm tall and under no pressure the separation between the stop 212 and the back plate 206 is approximately 20 micro meters. The stop 212 can be any conveniently shaped structure with any appropriate dimensions. Thus, the distance between the back plate and the stop (under no pressure) can be adjusted to fit the needs of the user and the system.

In one example of the operation of the microphone 200, sound energy 214 enters through the port 210 and vibrates the diaphragm 208 and this action creates a corresponding change in electrical potential (voltage) between the diaphragm 208 and the back plate 206. This voltage represents the sound energy that has been received. The voltage may be then transmitted to an electric circuit (e.g., an integrated circuit such as an application specific integrated circuit (ASIC) and not shown in the figure). Further processing of the signal may be performed on the electrical circuit. For instance, amplification or filtering functions may be performed on the voltage signal at the integrated circuit. The stop 212 prevents the back plate 206 from moving any further distance beyond a predetermined distance when the sound 214 exceeds a predetermined pressure. This prevents damage to the back plate 206 or other components of the microphone 200. In other words, the back plate does not break or break off and no damage to other components during high pressure sound events (e.g., high pressure sound entering via the port 210). When the level of sound pressure does not exceed a predetermined amount, the back plate 206 is not bent to a distance where it touches the stop 212.

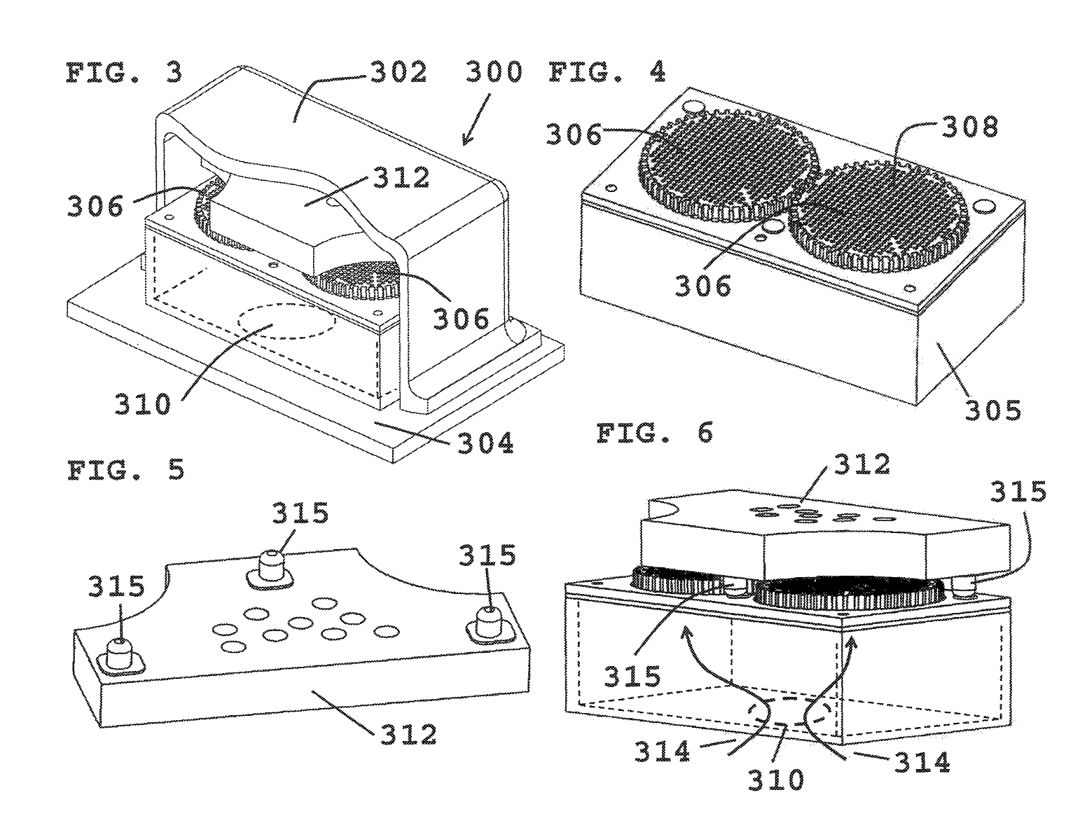

Referring now to FIGS. 3, 4, 5, and 6 a MEMS microphone apparatus 300 (including two microphone devices) is shown. The microphone apparatus 300 includes two separate microphone devices and includes a common cover 302, base 304. Each separate microphone includes a back plate 306 and diaphragm 308 (underneath the back plate 306). Port 310 extend through the base 304 to the respective individual microphone devices. A stop 312 is placed on pedestals 315 that rest on the base 305. The stop 312 prevents the back plates 306 from moving upward beyond a predetermined distance beyond which damage to the back plates or other components may occur. In one example, the stop 312 is constructed of silicon or metal and has dimensions of approximately 1 mm wide, approximately 2 mm long, and approximately 0.1 mm thick. In this example, the microphone apparatus 300 is approximately 1 mm tall and under no pressure the separation between the stop 312 and the back plates 306 is approximately 20 micro meters. The stop 312 can be any conveniently shaped structure with any appropriate dimensions. Thus, the distance between the back plate and the stop (under no pressure) can be adjusted to fit the needs of the user and the system. Additionally, the shape can be adjusted so that, for example, the stop does not cover the entirety of both back plates.

In one example of the operation of the microphone 300, sound energy 314 enters through the port 310 and vibrates one of the diaphragms (in one of the microphones) and this action creates a corresponding change in electrical potential (voltage) between the diaphragm 308 and the corresponding back plate 306. This voltage represents the sound energy that has been received. The voltage may be then transmitted to an electric circuit (e.g., an integrated circuit such as an application specific integrated circuit (ASIC) and not shown in the figure). Further processing of the signal may be performed on the electrical circuit. For instance, amplification or filtering functions may be performed on the voltage signal at the integrated circuit. The stop 312 prevents the back plate 306 from moving any further beyond a predetermined distance when the sound 314 exceeds a predetermined pressure. This prevents damage to the back plate 306 or other components of the associated microphone 300. In other words, the back plate does not break or break off and no damage to other components during high pressure sound events (e.g., high pressure sound entering via the ports 310). When the level of sound pressure does not exceed a predetermined amount, the back plates 306 do not bend to a distance where they touch the stop 312.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An acoustic device, comprising:
a substrate;
a microelectromechanical system (MEMS) apparatus, the MEMS apparatus including a diaphragm and a back plate;
a cover, the cover coupled to the substrate and enclosing the MEMS apparatus;
a port, the port disposed through the substrate, the MEMS apparatus being disposed over the port;
a stop, the stop disposed over the MEMS apparatus and configured to prevent movement of portions of the MEMS apparatus that would damage the portions of the MEMS apparatus.

2. The acoustic device of claim 1 wherein the stop extends over and around the MEMS apparatus and is coupled to the substrate.

3. The acoustic device of claim 1 wherein the stop is coupled to the cover.

4. The acoustic device of claim wherein the stop is support by at least one pedestal.

5. The acoustic device of claim wherein the at least one pedestal is coupled to the substrate.

6. The acoustic device of claim wherein the portions of the MEMS apparatus for which damage is prevented from occurring comprises the back plate.

7. The acoustic device of claim wherein the portions of the MEMS apparatus for which damage is prevented from occurring comprises the diaphragm.

8. The acoustic device of claim wherein an application specific integrated circuit (ASIC) is disposed on the substrate.
